(19) United States
(12) Patent Application Publication
(10) Pub. No.: US 2008/0214141 A1
(43) Pub. Date: Sep. 4, 2008

(54) SYSTEM AND METHOD FOR ALLOWING CALLBACK ON AN EMERGENCY CALL

(76) Inventors: Ian Benjamin Burdick, Frisco, TX (US); Srinivasa Rajan Kishan, Carrollton, TX (US); Dane Aderholt, Allen, TX (US)

Correspondence Address: ERICSSON INC., 6300 LEGACY DRIVE, M/S EVR 1-C-11, PLANO, TX, 75024, US

(21) Appl. No.: 11/680,693

(22) Filed: Mar. 1, 2007

(51) Int. Cl. H04M 11/04

(52) U.S. Cl. 455/404.1

(57) ABSTRACT

A system and method suspends incoming call-barring for a subscriber in a telecommunications network for a specified period of time when an emergency call is initiated by the subscriber. During the time period, there is no incoming call-barring for the subscriber making the emergency call and a call from any number can be received. The PSAP is thus allowed to call the subscriber in case the emergency call is disconnected without being completed.

### TECHNICAL FIELD

The present application generally relates to emergency calls in communication networks. More particularly, and not by way of limitation, the present application relates to a system and method regarding emergency calls that have been disconnected during the call.

### BACKGROUND

Typically when a telecommunications service subscriber dials an emergency number (e.g., 911), the call is setup to the nearest Public Safety Answering Point (PSAP). If the emergency call to the PSAP is disconnected, the PSAP will originate a call back to the subscriber that originally placed the emergency call.

### Prior Art and Problems

There are operator hosted services such as Centrex that have configurable incoming call barring capabilities. If the subscriber is associated with a service that has configurable incoming call barring capabilities and the configuration includes barring of incoming calls, the callback from the PSAP would be barred. The PSAP operator would not be able to reach the subscriber potentially increasing liability of the Centrex service operator

It is possible, in the core network, to bypass the call barring service in the case of an emergency callback. However, the core network may not always bypass the service in which case the call back from the PSAP would be barred.

It would be advantageous to have a system and method for allowing a PSAP to callback a disconnected emergency call that overcomes the disadvantages of the prior art. The present invention provides such a system and method.

### BRIEF SUMMARY

An emergency call callback method, in a telecommunications network with incoming call-barring, sets a timer to suspend a subscriber's incoming call-barring feature for a specified period of time. During the time period, there is no incoming call-barring for this subscriber and a call from any number can be received. The PSAP is thus allowed to call the subscriber in case the emergency call from the calling number is disconnected.

In another aspect, the present invention is directed to a system for completing an emergency call in a telecommunications network with incoming call-barring, wherein the telecommunications network comprises an Intelligent Network (IN) having a Service Control Point (SCP), Mobile Switching Center (MSC), E911 Service Provider, Public Safety Answering Point (PSAP) and at least one subscriber.

The system comprises a means for the at least one subscriber to initiate an emergency call which is received by the telecommunications network in a normal manner. The emergency call is received by the MSC and the MSC notifies a connected E911 Service Provider which then notifies the SCP of the emergency call and then routes the call to the nearest PSAP. Upon receiving the notification from the E911 Service Provider, the SCP starts a timer that disables incoming call barring for this subscriber for a predetermined period of time.

If another emergency call is initiated by this subscriber during this period of time, the SCP will be notified by the E911 Service Provider as mentioned above and the timer is reset. When the timer expires, the incoming call-barring is re-activated for this subscriber.

### BRIEF DESCRIPTION OF THE SEVERAL VIEWS OF THE DRAWING

The foregoing objects, features and advantages of the present invention, as well as other features, will be more readily understood upon reading the following detailed description in conjunction with the drawings in which:

FIG. 1 is a high-level block diagram of a system according to an embodiment of the present invention;

FIG. 2 depicts a high-level flow diagram of describing a process in accordance with an embodiment of the present invention; and

FIG. 3 illustrates a high-level flow diagram of a process for re-activating a call-bearing feature in accordance with an embodiment of the invention.

### DETAILED DESCRIPTION OF THE INVENTION

In the following description, for purposes of explanation and not limitation, specific details are set forth, such as techniques, etc. in order to provide a thorough understanding of the present invention. However, it will be apparent to one skilled in the art that the present invention may be practiced in other embodiments that depart from these specific details. In other instances, detailed descriptions of well-known methods, devices, and circuits are omitted so as not to obscure the description of the present invention.

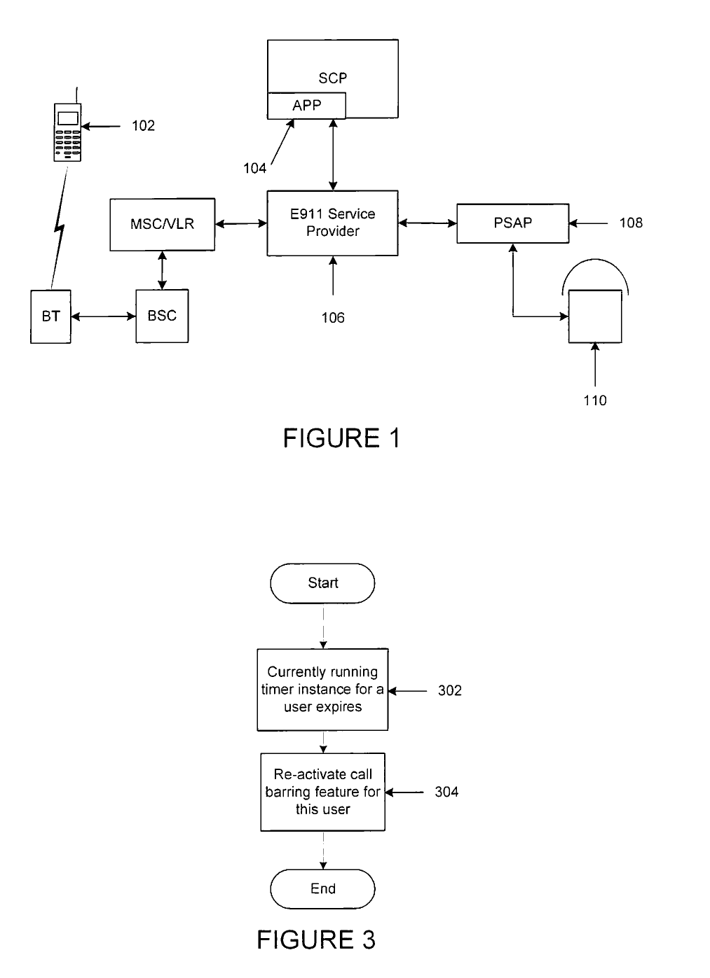

FIG. 1 is a high-level block diagram of a network in which an embodiment of the present invention may be incorporated. In a network incorporating Intelligent Network (IN) services, a wireless caller 102 in an associated Centrex network, may make an emergency call which is routed through the MSC. The MSC routes the call to E911 Service Provider 106. E911 Service Provider 106 then notifies the Centrex application 104 in the SCP that the wireless caller has placed an emergency call. The Centrex application 104 checks if the subscriber has the incoming call-barring feature active. If so, the Centrex application 104 will disable incoming call-barring for this subscriber and start a timer for a predetermined period of time.

The emergency call is routed to Public Safety Answering Point (PSAP) 108 which connects the emergency call to the appropriate emergency number 110 (fire department, police, etc.). The PSAP list of emergency numbers is configurable and can have additional numbers (such as, poison emergency lines, hazardous materials, National Response Center, etc.) that are associated with the user/subscriber.

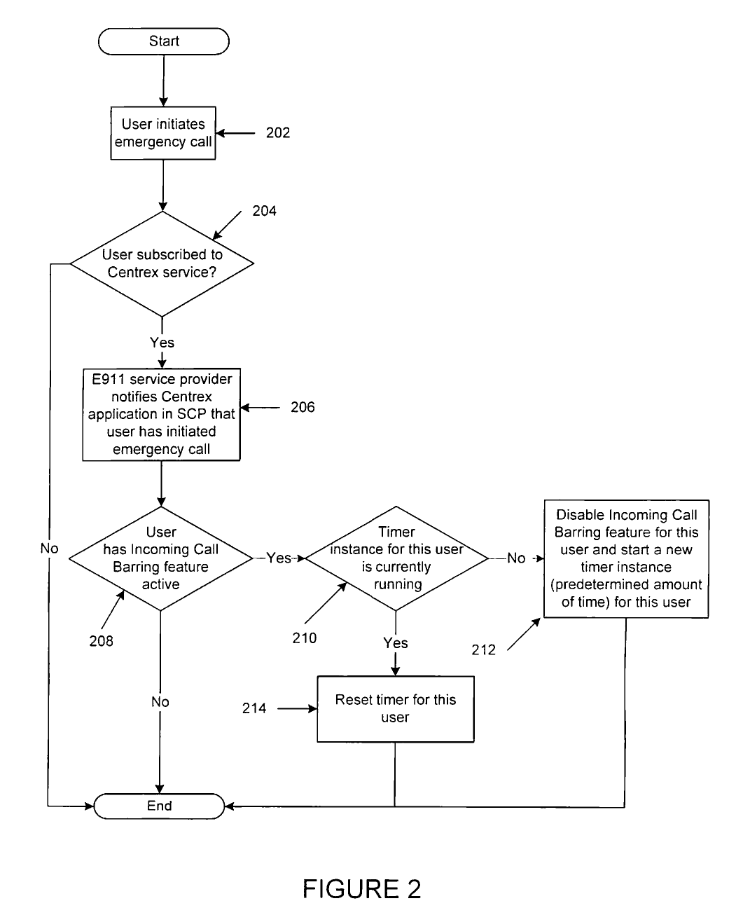

FIG. 2 illustrates a high-level flow diagram describing a process in accordance with an embodiment of the invention. The process begins with step 202 which illustrates a user/subscriber in a telecommunications network initiating an emergency call. The process continues to step 206 which depicts the E911 Service Provider notifying the Centrex application in the SCP that the user has initiated an emergency call.

The Centrex application in step 208 checks a profile of the caller to determine whether the user/subscriber has an incoming call-barring feature activated. If not, the process ends. If the user/subscriber does have the call-barring feature activated, the process next moves to step 210, where a determination is made whether a timer instance is currently running for this user/subscriber. If a timer instance is not running for this user/subscriber, the process moves to step 212 where the incoming call barring feature is disabled and a new timer instance is started for a predetermined period of time for this user/subscriber.

If the timer instance is currently running, the process moves to step 214 in which the timer instance is reset for a predetermined period of time for the user/subscriber.

FIG. 3 depicts a high-level flow diagram of a process for re-activating a call-barring feature in accordance with an embodiment of the invention. In step 302, which begins after an emergency call has been connected to the PSAP, the timer which had been started for a predetermined duration expires. Prior to step 302 as illustrated in FIG. 2, a timer is started, in association with the emergency call, and if the system operator has configured incoming call-barring in the system for this user/subscriber, the timer disables the call-barring feature for the user/subscriber's number for a predetermined period. If this user/subscriber initiates another emergency call while the timer is active, the E911 Service Provider will notify the SCP (see FIG. 1) of the emergency call as explained above and the timer will be reset. In the subsequent step 304, if no emergency call is initiated by this user/subscriber while the timer is active and the timer expires after the specified duration, the incoming call-barring will be reactivated for this subscriber.

The above-described exemplary embodiments are intended to be illustrative in all respects, rather than restrictive, of the present invention. Thus the present invention is capable of many variations in detailed implementation that can be derived from the description contained herein by a person skilled in the art. All such variations and modifications are considered to be within the scope and spirit of the present invention as defined by the following claims.

What is claimed:

1. In a telecommunications network with incoming call-barring, a method of completing an emergency callback, the method comprising:
a subscriber initiating an emergency call in the network;
connecting the subscriber to the nearest Public Safety Answering Point (PSAP) and simultaneously starting a timer for a predetermined period of time;
suspending the incoming call-barring for the subscriber during the predetermined period of time; and
reactivating the incoming call barring once the timer expires.

2. The method of claim 1, further comprising a step of determining whether a timer associated with the subscriber is currently operating and if so, resetting the currently operating timer.

3. The method of claim 1, wherein the connecting the subscriber step further comprises:
receiving notification that the subscriber has initiated an emergency call;
determining that the profile of the subscriber comprises the incoming call-barring feature; and
if the timer associated with the subscriber is not operating, starting a timer upon suspending the incoming call-barring feature for the subscriber.

4. The method of claim 1, further comprising the step of resetting the timer if another emergency call is made by that subscriber while the timer is running.

5. The method of claim 1, wherein the step of the subscriber initiating an emergency call further comprises:
routing the emergency call to an E911 Service Provider; and
the E911 Service Provider notifying a service control point in the network that the subscriber has initiated an emergency call.

6. The method of claim 1, wherein the telecommunications network is a wireless network.

7. In a telecommunications network with incoming call-barring, a system for completing an emergency call, the telecommunications network comprising an Intelligent Network (IN) having a Service Control Point (SCP), Mobile Switching Center (MSC), E911 Service Provider, Public Safety Answering Point (PSAP) and at least one subscriber the system comprising:
means for the at least one subscriber initiating an emergency call in the telecommunications network;
means for connecting the at least one subscriber to the nearest Public Safety Answering Point (PSAP) and simultaneously starting a timer;
means for suspending the incoming call-barring for the subscriber for a predetermined period of time;
means for re-activating the incoming call-barring once the timer expires.

8. The system of claim 7, wherein the means for connecting the at least one subscriber comprises
means for routing the emergency call to an E911 Service Provider and
means in the E911 Service Provider for sending notification to the SCP that the at least one subscriber has initiated an emergency call.

9. The system of claim 7, wherein the means for connecting the at least one subscriber further comprises
the SCP receiving notification that the at least one subscriber has initiated an emergency call the SCP then
checking the profile of the at least one subscriber;
determining that the profile comprises the incoming call-barring feature;
and
starting a timer upon suspending the incoming call-barring feature.

10. The system of claim 9, further comprising a means for determining whether a timer associated with the at least one subscriber is currently operating.

11. The system of claim 4, further comprising means for resetting the currently operating timer if an emergency call is made while the currently operating timer is running.

12. A node adapted for completing an emergency call in a telecommunications network having incoming call-barring the node comprising:
means for routing an at least one subscriber initiated emergency call in the telecommunications network;
means for connecting the at least one subscriber to the nearest Public Safety Answering Point (PSAP) and simultaneously starting a timer;
means for suspending the incoming call-barring for the subscriber for a predetermined period of time; and
means for re-activating the incoming call barring once the timer expires.

13. The node of claim 12, wherein the means for routing the at least one subscriber initiated emergency call further comprises:
means for routing the emergency call to an E911 Service Provider and
means for receiving from the E911 Service Provider a notification that the at least one subscriber has initiated an emergency call.

14. The node of claim 12, wherein the means for connecting the at least one subscriber further comprises:
means in the node for:
checking the profile of the at least one subscriber;
determining that the profile comprises the incoming call-barring feature; and
starting a timer upon suspending the incoming call-barring feature for the subscriber.

15. The node of claim 12, further comprising a means for determining whether a timer associated with the at least one subscriber is currently operating.

16. The system of claim 15, further comprising means for resetting the timer if another emergency call is made by that subscriber while the timer is running.

17. The node of claim 12, wherein the node is a Service Control Point (SCP).
